(19) United States
(12) Patent Application Publication
(10) Pub. No.: US 2011/0252695 A1
(43) Pub. Date: Oct. 20, 2011

(54) Bait Station Kit

(76) Inventor: Alan E. Pryor, Hartford, WI (US)

(21) Appl. No.: 12/887,968

(22) Filed: Sep. 22, 2010

Related U.S. Application Data
(60) Provisional application No. 61/324,162, filed on Apr. 14, 2010.

(51) Int. Cl. A01M 1/20; B65B 3/12

(52) U.S. Cl. 43/131; 222/1

(57) ABSTRACT

A bait station kit for use in terminating pests including a dispensing device including bait and a plurality of bait stations initially not including bait. The bait is preferably a gel and is contained in a dispensing device such as a syringe. The bait is dispensed from the syringe into the bait stations proximate to the time the bait stations are placed for accessibility by pests. The dispensing device preferably contains an amount of bait more than sufficient to fill all of the plurality of bait stations.

### CROSS-REFERENCE TO RELATED APPLICATION

This patent application claims priority of U.S. Provisional Patent Application No. 61/324,162, which is entitled “Bait Station Kit,” and which was filed on Apr. 14, 2010, which patent application is hereby incorporated herein by reference in its entirety.

### BACKGROUND OF THE INVENTION

### Field of the Invention

The present invention relates generally to bait kits, and more particularly to ant and roach bait kits having multiple bait stations and a dispensing device for filling and refilling the bait stations as well as for dispensing bait at locations other than into the bait stations.

Pests such as ants and roaches and infestations of the same are typically undesirable for consumers. Consumers tend to deal with such undesirable pests by placing bait tending to attract these pests throughout areas of homes. The pests find and ingest the bait or carry it back to their nesting places. The bait contains an active ingredient designed to exterminate the pests, either immediately or over time.

In the past, bait could be purchased by consumers in pre-loaded bait stations. The bait stations were provided with a removable portion configured to be broken off by the consumer when the bait stations were ready to be placed. By breaking off the removable portion, the consumer would expose the bait, allowing pests to access it.

Such a configuration has significant disadvantages. A significant portion of the cost of producing such bait stations is the cost of filling the bait station with bait material. Additionally, such bait stations that are pre-filled with bait material have a limited shelf life. Further, the bait station must be manufactured with the additional removable portion which will merely be disposed of by the consumer prior to use.

Therefore, it will be appreciated that it would be desirable to provide bait stations that would eliminate the cost of pre-filling them. Additionally, it would be desirable to provide bait stations that have extended shelf life. Moreover, it would be desirable to provide bait stations that do not require an additional removable portion that when removed will simply be disposed of.

The bait station kit of the present invention must also be of construction which is both durable and long lasting, and it should also require little or no maintenance to be provided by the user throughout its operating lifetime. In order to enhance the market appeal of the bait station kit of the present invention, it should also be of inexpensive construction to thereby afford it the broadest possible market. Finally, it is also an objective of the present bait station kit that all of the aforesaid advantages and objectives be achieved without incurring any substantial relative disadvantage.

### SUMMARY OF THE INVENTION

The disadvantages and limitations of the background art discussed above are overcome by the present invention. With this invention, a bait station kit is provided that includes a plurality of bait stations and a single bait dispensing syringe. The bait stations each define a bait reservoir accessible from at least one externally accessible opening that is configured to be accessed by a pest. Each bait station further provides a bait loading port providing access to the bait reservoir to the bait dispensing syringe. The bait dispensing syringe has a plunger at proximal end thereof and a dispensing nozzle at a distal end thereof. The plunger end is configured to dispense bait from the distal dispensing end when the plunger end is actuated. The bait dispensing syringe contains more than enough bait to fill each of the bait reservoirs of each of the plurality of bait stations included in the bait station kit.

In another aspect, the present invention provides a bait dispensing device including a first amount of bait and a plurality of bait stations each including a bait reservoir. The bait reservoirs are empty, and the total capacity of all of the bait reservoirs is equal to a second amount that is less than the first amount. The bait dispensing device is configured to dispense bait within each of the bait reservoirs through an aperture located in each of the bait stations.

In another aspect, the present invention teaches providing a bait dispensing device including an actuation portion coupled to a bait compartment that contains an amount of bait. The bait compartment is in fluid communication with a dispensing portion of the bait dispensing device. The actuation portion is configured to selectively control dispensing of bait from the dispensing portion. The method further includes providing a plurality of bait stations each including a bait reservoir accessible by the bait dispensing device through a filling aperture defined in each of the bait stations. The bait stations also each define at least one pest aperture in communication with each of the bait reservoirs. The pest apertures are configured to allow a pest to access the bait reservoirs. The method also includes packaging the bait dispensing device containing bait along with the plurality of bait stations not initially containing bait in a single kit.

In another aspect, the present invention teaches a bait station kit including a plurality of bait stations each including a top piece defining a bait loading port, a first attachment piece, and at least one projection. The bait stations also include a bottom piece defining a bait reservoir, and a second attachment piece configured to cooperate with the first attachment piece to couple the top piece to said bottom piece. The top piece also includes at least one notch configured to interact with the at least one projection to at least one of provide correct orientation of the top piece with respect to the bottom piece and prevent rotation of the top piece relative to the bottom piece when the top piece is coupled with the bottom piece. The bait station kit also includes a dispensing device including bait configured to dispense the bait into the bait reservoir.

The bait station kit of the present invention is of a construction which is both durable and long lasting, and which will require little or no maintenance to be provided by the user throughout its operating lifetime. The bait station kit of the present invention is also of inexpensive construction to enhance its market appeal and to thereby afford it the broadest possible market. Finally, all of the aforesaid advantages of the bait station kit of the present invention are achieved without incurring any substantial relative disadvantage.

### DESCRIPTION OF THE DRAWINGS

These and other advantages of the present invention are best understood with reference to the drawings, in which:

FIG. 1 shows an isometric view of an embodiment of the bait station kit in accordance with the teachings of the present invention;

FIG. 2 shows an isometric view of an embodiment of a syringe in accordance with teachings of the present invention;

FIG. 3 shows a partial cross-sectional view of the syringe of FIG. 2;

FIG. 4 shows an exploded view of the exemplary bait station of FIG. 1 prior to being filled with bait;

FIG. 5 shows a cross-sectional view of the bait station of FIG. 4;

FIG. 6 shows the bait station and syringe of FIG. 1 with the distal dispensing end of the syringe inserted through the bait loading port into the bait station prior to filling with bait;

FIG. 7 shows the bait station and syringe of FIG. 1 as the plunger of the syringe is being depressed and the bait reservoir is being filled with bait;

FIG. 8 shows the syringe of FIG. 1 dispensing bait onto a surface;

FIG. 9 shows an isometric view of a second embodiment of a bait station in accordance with the teachings of the present invention;

FIG. 10 shows an exploded view of the bait station of FIG. 9;

FIG. 11 shows a cross-sectional view of the top piece of the bait station of FIGS. 9 and 10;

FIG. 12 shows a cross-sectional view of the bottom piece of the bait station of FIGS. 9 and 10;

FIG. 13 shows an isometric view of a third embodiment of a bait station in accordance with the teachings of the present invention;

FIG. 14 shows an exploded view of the bait station of FIG. 13;

FIG. 15 shows a cross-sectional view of the top piece of the bait station of FIGS. 13 and 14;

FIG. 16 shows a cross-sectional view of the bottom piece of the bait station of FIGS. 13 and 14; and

FIG. 17 shows cross-sectional view of the assembled bait station of FIG. 13.

### DETAILED DESCRIPTION OF THE EXEMPLARY EMBODIMENTS

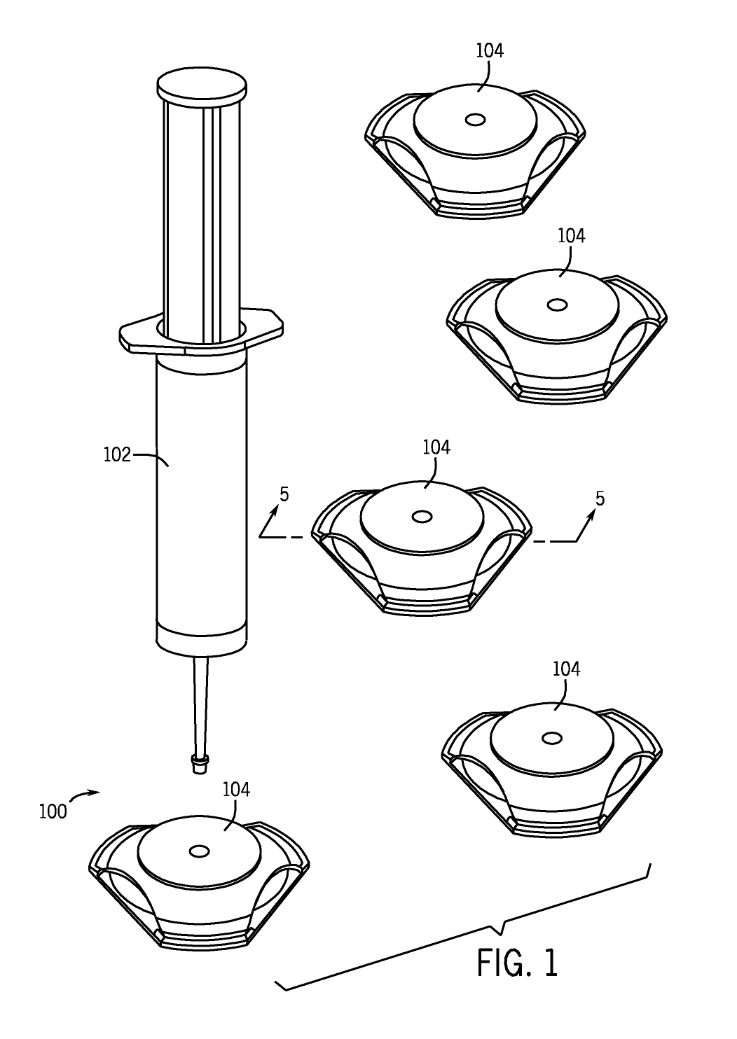

Referring initially to FIG. 1, an exemplary embodiment of a bait station kit 100 in accordance with the teachings of the present invention is illustrated. Pests to be targeted may include ants and roaches, as well as other insects and vermin. The bait station kit 100 preferably is provided with a dispensing device, in the illustrated embodiment a syringe 102, and a plurality of bait stations 104. The bait stations 104 are configured to be placed on various surfaces. The syringe 102 is initially filled with bait, while the bait stations 104 initially are empty.

As will be described further below, preferably immediately prior to the time of placing the bait stations 104, a user will use the syringe 102 to dispense bait into one or more of the bait stations 104. The bait station(s) 104 is (are) then placed in a location (locations) accessible by pests. When pests access the bait disposed within the bait stations 104 and eat the bait, they will be exterminated by the active ingredient included in the bait.

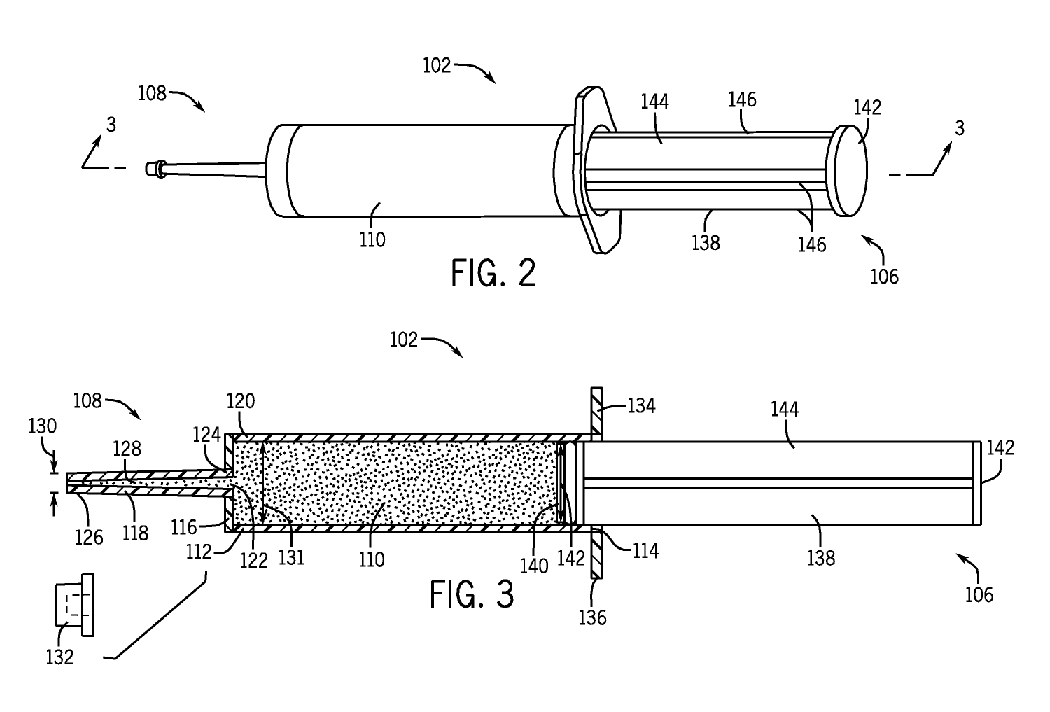

With reference to FIG. 2, in one embodiment the syringe 102 includes a proximal or plunger end 106 and a distal nozzle or dispensing end 108. Disposed between the plunger end 106 and the distal dispensing end 108 of the syringe 102 is a syringe bait holding compartment 110. With reference to FIG. 3, the syringe bait holding compartment 110 is preferably a tubular compartment having a first end 112 and a second end 114, the bait holding compartment 110 being coupled to the distal dispensing end 108 proximate the first end 112 and forming a leak-proof seal with the plunger end 106 proximate the second end 114.

Alternately, the described portions of the syringe 102 may be formed as a single unitary piece. The syringe 102 is preferably formed from molded or extruded plastic; however, any other suitable material known in the art may instead be used.

With further reference to FIG. 3, in one embodiment the distal dispensing end 108 of the syringe 102 includes a annular wall 116 and a dispensing tip portion 118. The annular wall 116 is preferably impermeably sealed proximate the radially outer portion of the annular wall 116 to the annular wall 120 that defines the syringe bait holding compartment 110. The annular wall 116 and the annular wall 120 may be formed as a single unitary piece. Alternately, the annular wall 116 may be bonded to the annular wall 120 by heat staking or any other suitable bonding process.

The annular wall 116 defines an aperture 122, preferably located proximate the center of the annular wall 116. The aperture 122 is in fluid communication with a first end 124 of the dispensing tip portion 116.

The dispensing tip portion 116 includes a first end 124 and a second end 126, spaced apart from and in fluid communication with the first end 124 through a dispensing channel 128. The first end 124 is disposed within the aperture 122 in the annular wall 116, placing the dispensing channel 128 into fluid communication with the syringe bait holding compartment 110. The second end 126 of the dispensing tip portion 116 has an outer diameter 130 that is preferably smaller than the inner diameter 131 of the syringe bait holding compartment 110. These diameters 130 and 131 may be uniform throughout each of the pieces, or they may gradually decrease proceeding away from the plunger end 106.

The syringe bait holding compartment 110 is preferably cylindrical and extends from the first end 112 to the second end 114. At the second end 114 the annular wall 120 preferably terminates in at least one and preferably two opposing first and second finger flanges 134 and 136. The finger flanges 134 and 136 project radially outwardly from the annular wall 120. The finger flanges 134 and 136 are preferably located radially 180 degrees from one another and are configured to assist a user with operation of a plunger 138.

With reference to FIGS. 2 and 3, the plunger 138 preferably includes a disk portion 140 with a diameter 142. The diameter 142 of the disk portion 140 is selected to be approximately the same as the inner diameter 131 of the syringe bait holding compartment 110. Thus, the disk portion 140 will form a substantially impermeable but linearly moveable seal with the annular wall 120 of the syringe bait holding compartment 110.

The plunger 138 further includes an activation portion 142 preferably parallel with and spaced apart from the disk portion 140 of the plunger 138. The activation portion 142 is operably coupled to the disk portion 140 by an axially extending connecting portion 144. In one embodiment the connecting portion 144 includes four ribs 146 projecting radially from a center connecting portion 148 (only three ribs 146 are illustrated in FIG. 2).

Referring again to FIG. 3, the syringe 102 in one embodiment additionally includes a selectively removable cap 132. The selectively removable cap 132 is configured to engage the second end 126 of the dispensing tip portion 118 and form an impermeable seal, preventing the contents of the syringe 102 from leaking out of the dispensing tip portion 118 and contaminants from entering the syringe 102.

The syringe bait holding compartment 110 is preferably filled with a volume/mass of bait. For example, the compartment 110 may be filled with thirty grams of bait, though other amounts of bait may instead be used. The bait is preferably a fluid or a gel, and preferably includes both an active ingredient and an inactive ingredient. If the pests to be targeted are ants, the bait may, for example, be a gel marketed by the DuPont corporation under the trademark ADVION™. ADVION™ includes the active ingredient INDOXACARB (S-Enantiomer) in a concentration of between approximately 0.02% and 0.06% by mass, and preferably 0.03% by mass. However, other suitable baits may be used for targeting ants. If the pests to be targeted are roaches, the bait may, for example, be ADVION™ containing INDOXACARB (S-Enantiomer) in a concentration of between approximately 0.20% and 0.60% by mass, and preferably approximately 0.30% by mass. If the pests to be targeted are other vermin, other suitable baits may be used.

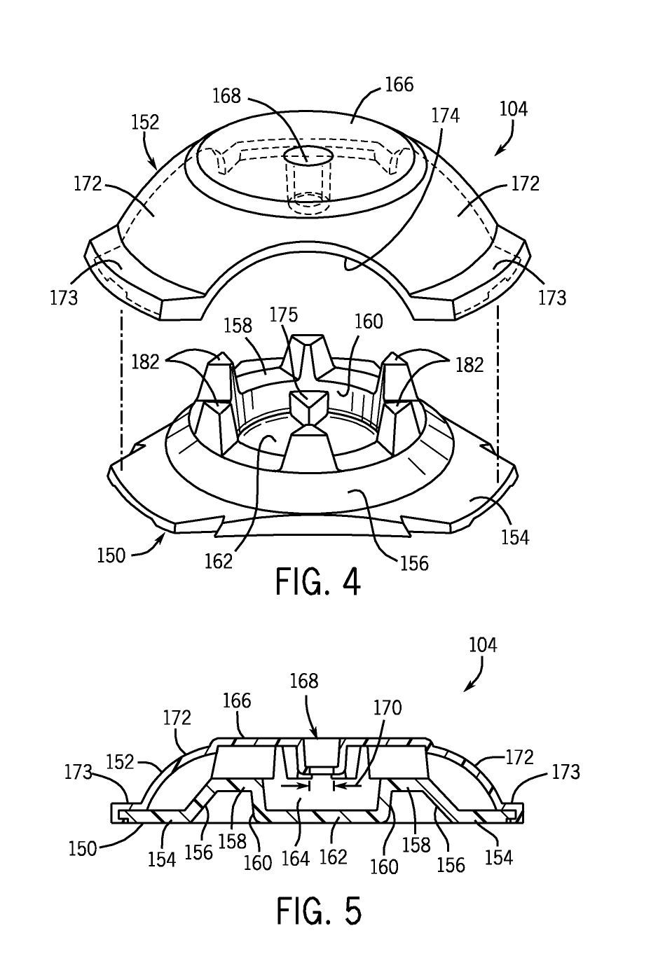

With reference to FIGS. 4 and 5, an exemplary bait station 104 is illustrated. The bait station 104 includes a bottom member 150 coupled to a top member 152. The bottom member 150 may be formed of plastic material and is defined by a flat bottom outer surface 154 that is annular with three essentially arcuate indentations forming a somewhat triangular configuration. This outer surface 154 transitions obliquely upwardly into a frustroconical transition portion 156. The transition portion 156 is coupled distal from the outer surface 154 to an upwardly facing rim portion 158. The rim portion 158 is coupled to a bait reservoir annular sidewall 160, which, along with a bait reservoir bottom portion 162, to which the annular sidewall 160 is coupled, defines a recessed bait reservoir 164. In the bait station kit 100 (illustrated in FIG. 1) the bait stations 104 are provided with empty bait reservoirs 164. Integrally formed with and extending upwardly from the wall 160 defining the bait reservoir 164 are a plurality of angularly spaced apart projections 182.

The top member 152 of the bait station 104 is preferably formed from transparent or translucent plastic material, and includes a circular flat top surface 166 which defines at least one bait loading port 168 contained therein which has at its lower end a reduced internal diameter 170 (best shown in FIG. 5). Coupled to the flat top surface 166 proximate its radially outer portion are three downwardly projecting arcuate portions 172 having outwardly-extending flanges 173. These outwardly-extending flanges 173 are preferably heat staked, welded, glued, or coupled by another suitable method to the top of the bottom member 150 at the flat bottom surface 154 proximate the radial outer edges of the flat bottom surface 154.

The downwardly projecting portions 172, along with the bottom member 150, define three access ports 174 through which pests may enter the bait station 104 and gain access to bait placed in the bait reservoir 164. These access ports 174 are preferably sized to allow pests easy entry into the bait station 104 while preventing access to the bait by small children or pets.

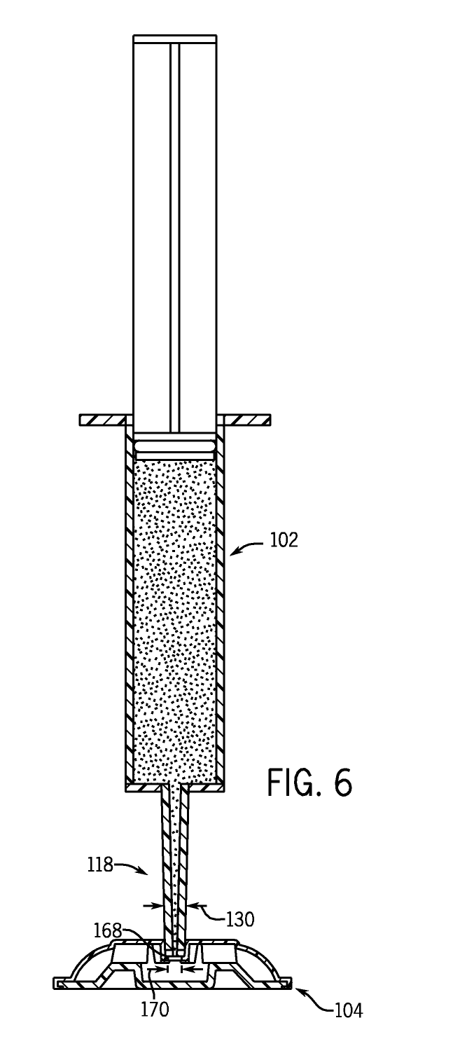

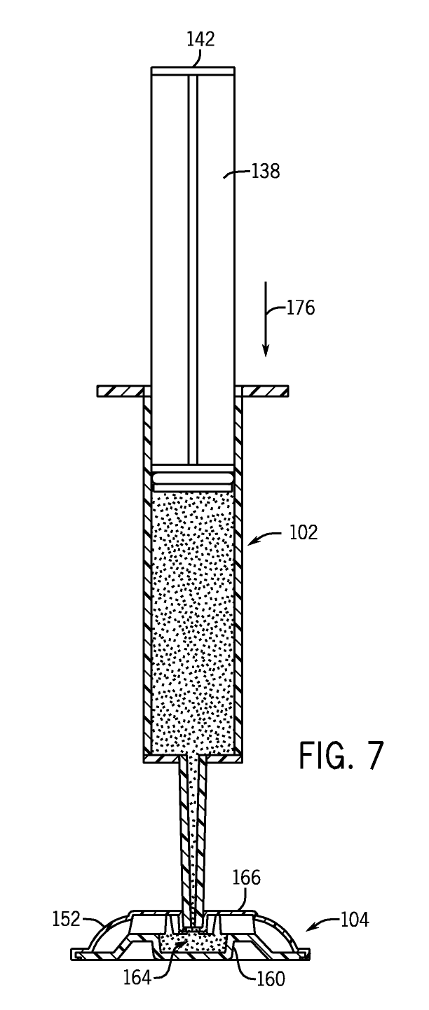

With reference to FIGS. 6 and 7, the bait station 104 is placed on a flat surface and the dispensing tip portion 118 of the syringe 102 is inserted into the bait loading port 168 in the bait station 104. The outer diameter 130 of the dispensing tip portion 118 of the syringe 102 is sized appropriately with respect to the diameter 170 of the bait loading port 168 of the bait station 104 to allow the dispensing tip portion 118 to fit therein. As illustrated in FIG. 7, as the activation portion 142 of the plunger 138 of the syringe 102 is depressed in an axial direction 176 substantially perpendicular to the flat top surface 166 of the bait station 104, bait is dispensed from the syringe 102 into the bait reservoir 164 of the bait station 104.

Because the top member 152 of the bait station 104 is preferably made from transparent or translucent plastic, a user is able to see into the bait reservoir 164 as the user actuates the plunger 138 of the syringe 102. Thus, the user can determine how much bait has been dispensed into the bait reservoir 164, and can thereby avoid overfilling the bait station 104. Alternately, the bait reservoir annular sidewall 160 may be provided with a fill line or other suitable marking (not shown in FIG. 7) to indicate to the user when an appropriate amount of bait has been dispensed into the bait reservoir 164. The fill line may be formed by marking or scoring the bait reservoir annular sidewall 160 or by any other suitable means of creating an indicator to indicate to a user when the bait reservoir 164 has been filled with a proper amount of bait. For example, in FIG. 4, the fill line is indicated by a triangular fill protrusion 175 that is molded into the bait reservoir 164 and extends axially upwardly from the bait reservoir bottom portion 162 and radially inwardly from the annular sidewall 160. In a preferred embodiment, the fill line is located at a point where the bait reservoir is approximately three-quarters full.

In an alternate embodiment (not illustrated), the bait loading port 168 may further include a one-way valve. The one-way valve may be actuated by the dispensing tip portion 118 of the syringe 102 to allow bait to be dispensed into the bait reservoir 164. However, once the dispensing tip portion 118 of the syringe 102 is removed, the one-way valve forms an impermeable seal preventing bait from leaving the bait reservoir 164 and contaminants from entering the bait reservoir 164 through the bait loading port 168.

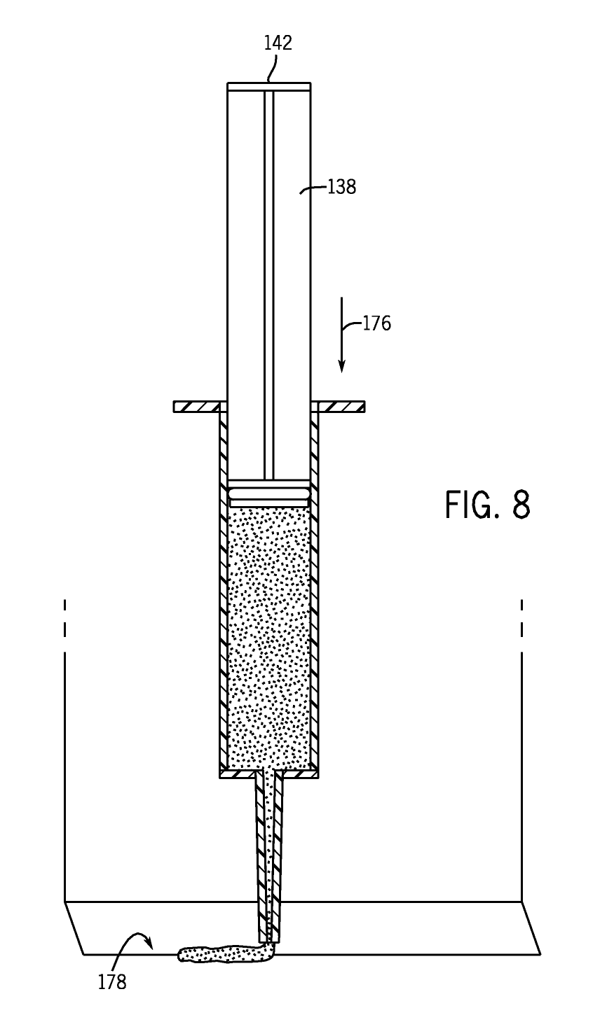

Referring again to FIG. 1, the syringe 102 preferably contains between approximately 20 and 60 grams of bait, and more preferably contains approximately 30 grams of bait. Each bait station 104 preferably has a capacity of between approximately 1 and 5 grams of bait, and more preferably a capacity of approximately 2 grams. Thus, in the preferred embodiment, the syringe 102 can be used to fill each of the 5 bait stations 104 contained in the bait station kit 100 to their full capacity of approximately 2 grams, and still have 28 grams of bait remaining within the syringe 102. This remaining bait may be used to fill other bait stations 104, saved and stored for later use to refill the bait station(s) 104 after the bait has been consumed by pests, or for some other use. One such other use is illustrated in FIG. 8, wherein the bait remaining in the syringe 102 may be dispensed directly to areas 178 such as corners of a floor, window sills, or any other area accessible by pests. This may be useful for dispensing bait in places that are unsuitable for the bait stations 104 due to location, size, or other constraints.

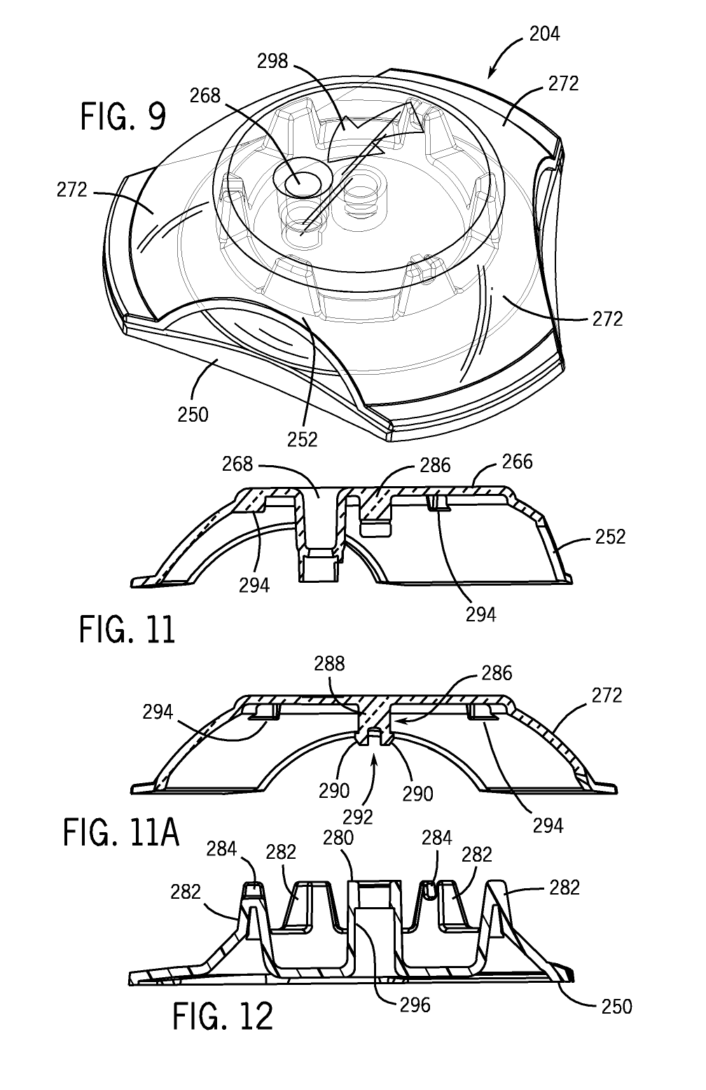

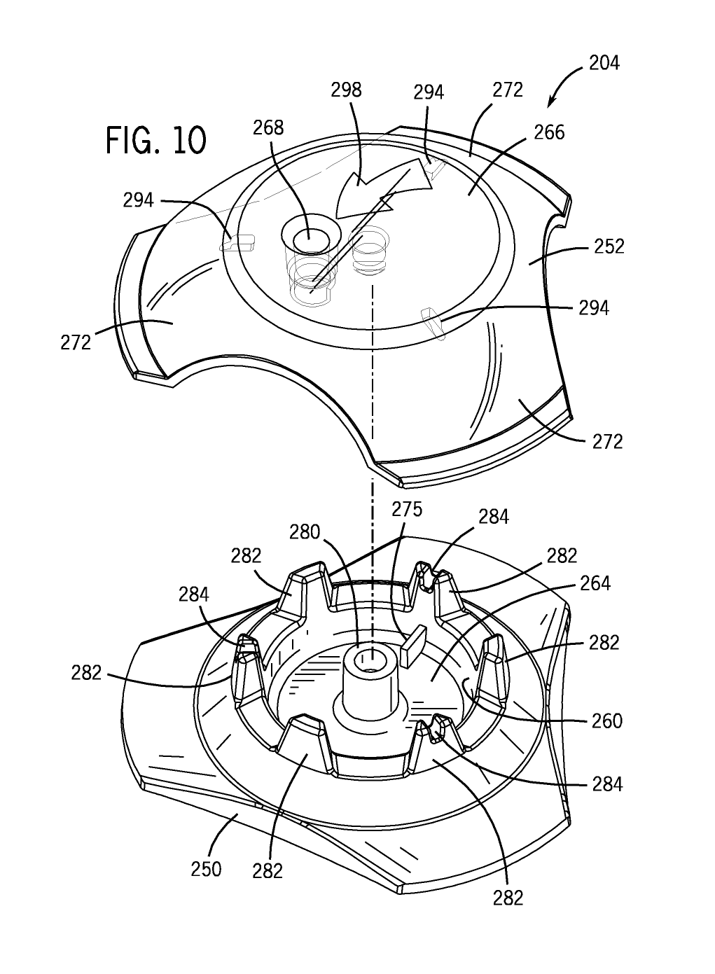

With reference to FIGS. 9 and 10, a second embodiment of a bait station 204 is illustrated. The bottom member 250 of the bait station 204 defines an annular bait reservoir 264, and is generally similar in construction to the bottom member 150 of the bait station 104 shown in FIGS. 4 and 5, with several exceptions that will be discussed herein in detail. An attachment cylinder 280 is formed preferably at the center of the bait reservoir 264, and extends axially upwardly therefrom. As will be described further below, the attachment cylinder 280 is configured to couple the bottom member 250 to the top member 252.

In one embodiment, integrally formed with and extending upwardly from the wall 260 defining the bait reservoir 264 are a plurality of projections 282. The projections 282 may be evenly arranged around the periphery of the bait reservoir 264 and extend axially proximate or in contact with the top member 252 when the bait station 204 is in an assembled configuration. In the illustrated embodiment, the bottom member 250 includes six projections 282 arranged circumferentially equidistant around the periphery of the wall 260.

In one embodiment, defined in the portion of at least one of the projections 282 distal from the bait reservoir 260 is a locating notch 284. In the illustrated embodiment, three of the six projections 282 define locating notches 284. Each of the projections 282 defining a locating notch 284 are located between a pair of projections 282 that do not define a locating notch 284.

In one embodiment, the bait reservoir 16 may include a fill indicator 276 projecting radially upwardly from the bottom of the bait reservoir 264 and coupled to the wall 260. The fill indicator 275 may be integrally molded with the bottom member 250, or it may be molded separately and be attached thereto. The fill indicator 275 may serve to indicate when a proper amount of bait is deposited in the bait reservoir 264, and may also indicate to a user the amount of bait remaining in the bait reservoir 264, as well as when the bait reservoir 264 no longer contains sufficient bait.

With reference to FIGS. 9-11, the bait station also includes a top member 252. In one embodiment, the top member 252 is a single molded plastic part made of any suitable material known in the art. Alternatively, various other materials for forming the top member 252 may instead be used. In one embodiment the top member 252 is transparent or translucent. Additionally, the top member 252 may be formed of various components coupled together.

In one embodiment, the top member 252 includes a circular flat disc-like portion 266. Projecting arcuately radially outwardly and axially downwardly from the disc-like portion 266 are three arcuate portions 272.

The underside of the disc-like portion 266 defines at its center in one embodiment an expansion plug 286 extending axially downwardly from the disc-like portion 266. The expansion plug 286 includes a base cylinder 288 coupled at one end to the disc-like portion 266. The free end of the base cylinder 288 is coupled to a pair of expansion teeth 290 separated by an expansion groove 292. As will be more fully explained below, the expansion plug 286 is configured to couple with the attachment cylinder 280 to join the top member 252 to the bottom member 250.

The underside of the disc-like portion 266 additionally defines near its periphery a plurality of locating projections 294. The locating projections 294 may extend radially outwardly to and couple to the arcuate portions 272. In one embodiment the number of locating projections 294 will be equal to the number of locating notches 284 defined in the projections 282 of the bottom member 250. The locating projections 294 are configured to interact with the locating notches 284 to properly orient the top member 252 relative to the bottom member 250. If the locating projections 294 are positioned over projections 282 without locating notches 284, the expansion plug 286 will not properly engage the attachment cylinder 280. Thus, the locating projections 294 may serve an indexing function.

As may be best seen in FIGS. 10-12, the bottom portion 250 and the top portion 252 may be joined together by aligning the expansion plug 286 with the attachment cylinder 280 and aligning the locating projections 294 with the locating notches 284. The top member 252 and the bottom member 250 may then be urged together. When the expansion teeth 290 contact the attachment cylinder 280, in one embodiment the expansion teeth 290 will be urged towards one another, reducing the size of the expansion groove 292 and allowing the expansion teeth 290 to pass into the attachment cylinder 280. As the top member 252 and the bottom member 250 continue to be urged together, the expansion plug 286 will continue to travel down the attachment cylinder 280 until the expansion teeth 290 reach an increased diameter portion 296 of the attachment cylinder 280.

At the point, the expansion teeth 290 will flex outwardly and return to their initial separation and thereby return the expansion groove 292 to its initial size prior to the insertion of the expansion plug 286 into the attachment cylinder 280. Thus the tops of the expansion teeth 290 will be prevented from moving upwardly back out of the attachment cylinder 280 by the narrower portion of the attachment cylinder 280. Additionally, the top member 252 and the bottom member 250 will prevented from rotating relative to one another by the engagement of the locating projections 294 with the locating notches 284.

Thus, it may be appreciated that, in this embodiment, once the top member 252 is attached to the bottom member 250, the two members 250 and 252 are not easily removed from one another. In other embodiments, suitable mechanisms known in the art for releasing the top member 252 and the bottom member 250 may be included. Additionally, the expansion plug 286 may be a cylinder designed to have an interference fit with the attachment cylinder 280. Alternately, the attachment cylinder 280 and the expansion plug 286 may be attached with adhesive or by any other suitable method known in the art.

In one embodiment, the disc portion 266 defines a bait loading port 268 contained therein. The bait loading port 268 may interface with a syringe as described in previous embodiments. Defined in the disc portion 266 may be an indicator 298 such as an arrow that indicates to a user the location of the bait loading port 268. The indicator 298 may be scored into the surface of the top member 252, may be drawn onto the top piece by any suitable means known in the art, or may be applied to the top member 252 in the form of a sticker. Other methods of indicating the location of the bait loading port 268 are also contemplated.

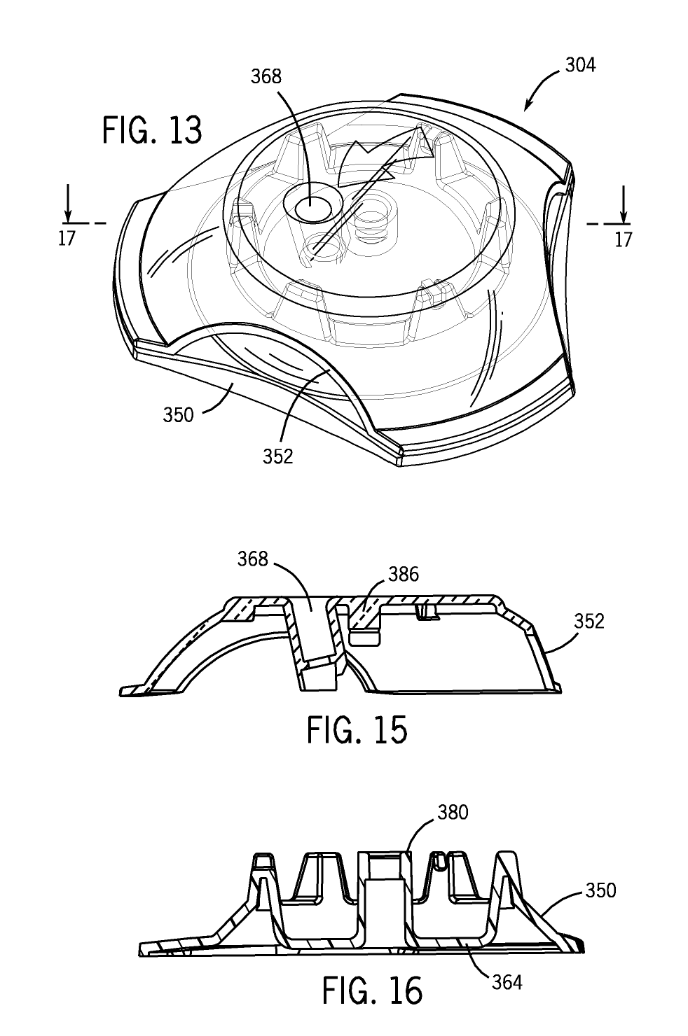

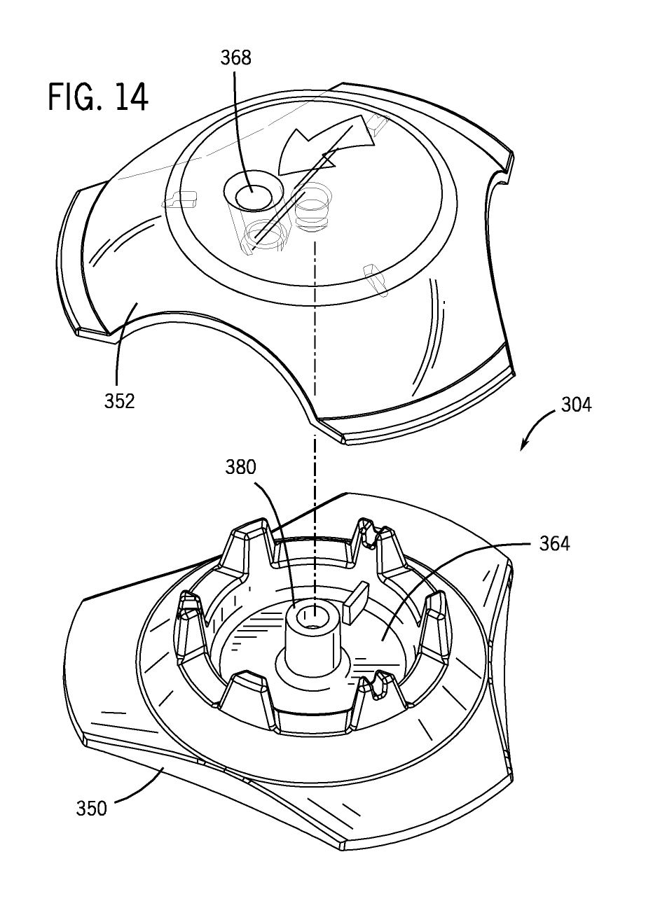

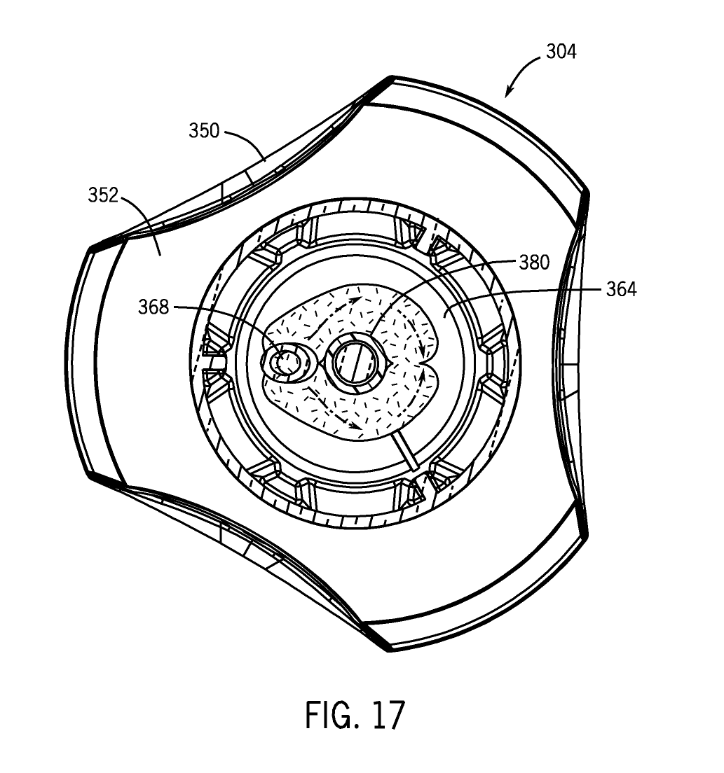

FIGS. 13-16 illustrate a third embodiment of a bait station 304. The bait station 304 is similar to the bait station 204 in various respects; however, while the bait loading port 268 of the second embodiment of the bait station 204 is defined substantially axially parallel to the expansion plug 286, the bait loading port 368 of the bait station 304 is defined at an angle oriented progressively further towards the expansion plug 386.

When the top piece 352 and the bottom piece 350 are engaged, a syringe may be inserted into the bait loading port 368. Bait dispensed from the syringe will be directed towards the center of the attachment cylinder 380 defined in the bottom piece 350. When the bait encounters the attachment cylinder 380, it will tend to divide into two portions of bait, one proceeding clockwise around the attachment cylinder 380, and the other proceeding counterclockwise around the attachment cylinder 380. When the two portions of bait meet on the side of the attachment cylinder 380 distal from the bait loading port 368, this will indicate to a user (through the transparent top piece 352) that the bait reservoir 364 has been filled with the proper amount of bait.

For purposes of this disclosure, the term “coupled” means the mechanical joining of two components directly or indirectly to one another. Such joining may be stationary in nature or moveable in nature. Such joining may be achieved with the two components and any additional intermediate members being integrally formed as a single unitary body with one another or the two components and any additional member being attached to one another. Such joining may be permanent in nature or alternatively be removable or releasable in nature.

Although the foregoing description of the bait station kit of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. A bait station kit comprising:
a plurality of bait stations, each of said bait stations comprising a bait reservoir accessible from at least one externally accessible opening that is configured to be accessible by a pest;
each of said bait stations further comprising at least one bait loading port providing external access to said bait reservoir; and
a bait dispensing syringe, said dispensing syringe including a plunger that is slidably disposed in a proximal end of said bait dispensing syringe and a nozzle disposed at a distal end of said bait dispensing syringe, said bait dispensing syringe being configured to dispense bait from said nozzle into said bait reservoir of said bait station when said nozzle is inserted into said bait loading port in said bait station and said plunger is actuated; and
wherein said dispensing syringe includes at least a sufficient amount of bait to sufficiently fill said bait reservoirs of each of said bait stations in the bait station kit.

2. The bait station kit of claim 1, wherein each of said bait reservoirs of the plurality of bait stations comprises a fill indicator located therein that indicates to a user when a sufficient amount of bait has been dispensed into each of said bait reservoirs.

3. The bait station kit of claim 2, wherein said fill indicator is defined at a location in each of said bait reservoirs indicating that three-quarters of the capacity of said bait reservoir has been reached.

4. The bait station kit of claim 1, wherein said dispensing syringe includes an amount of bait additional to that required to sufficiently fill each of said bait reservoirs of said bait stations.

5. The bait station kit of claim 1, wherein said dispensing syringe includes between approximately 20 and approximately 60 grams of bait, and wherein each of said bait reservoirs in each of said bait stations has a capacity of between approximately 1 and approximately 5 grams.

6. The bait station kit of claim 1, wherein said bait comprises a gel.

7. The bait station kit of claim 1, further comprising:
a one-way valve disposed within said bait loading port, said one-way valve configured to allow bait to enter said bait reservoir through said bait loading port but to inhibit bait from leaving said bait reservoir through said bait loading port.

8. The bait station kit of claim 1, wherein said bait stations comprise:
a top member defining a first attachment element; and
a bottom member defining a second attachment element;
wherein said first and second attachment elements are configured to cooperatively couple said top piece to said bottom piece; and
wherein said bait stations may be filed without detaching said top member from said bottom member.

9. The bait station kit of claim 8, wherein said bait loading port is centrally disposed in said top member.

10. The bait station kit of claim 8, wherein said first and second attachment elements are centrally disposed in said top member and said bottom member, respectively, and wherein said bail loading port is radially offset from the center of said top piece.

11. The bait station kit of claim 10, wherein said bait loading port is angularly disposed in said top member such that when said nozzle is inserted into said bait loading port in said bait station the distal end of said nozzle is angled toward an axis defined by the center of said top piece.

12. The bait station kit of claim 8, wherein said top member is either transparent or sufficiently translucent to allow bait filled into said bait reservoir to be viewed therethrough.

13. A bait station kit comprising:
a dispensing device, the dispensing device containing a first amount of bait; and
a plurality of bait stations, the bait stations each having a bait reservoir, the total capacity of all of the bait reservoirs of all of the bait stations in the bait station kit being equal to a second amount of bait, the first amount of bait being greater than the second amount of bait;
wherein the dispensing device is configured to dispense bait into the bait reservoirs through a bait loading port defined in each of said bait stations.

14. The bait station kit of claim 13, wherein said dispensing device comprises a syringe.

15. The bait station kit of claim 13, additionally comprising:
instructions regarding both the dispensing of bait into said bait stations and the dispensing of bait other than into said bait stations.

16. The bait station kit of claim 13, wherein said dispensing device contains at least twice the amount of bait necessary to fill the bait reservoirs of each of said bait stations in the bait station kit.

17. The bait station kit of claim 13, wherein each of said bait stations comprises:
a one-way valve disposed within said bait loading port, said one-way valve allowing said dispense bait into said bait reservoirs therethrough but not allowing bait to leave said bait reservoirs therethrough.

18. A method of making a bait station kit, the method comprising the steps of:
providing a dispensing device, said dispensing device including an actuation member operatively coupled to a bait compartment containing an amount of bait, said bait compartment being in fluid communication with a dispensing member, said actuation member being configured to selectively dispense bait from said dispensing member;
providing a plurality of bait stations, said bait stations each comprising a bait reservoir accessible by said dispensing member of said dispensing device through a bait loading port located in each of said bait stations, said bait stations further each comprising at least one externally accessible pest access aperture in communication with said bait reservoir that is configured to allow a pest to access said bait reservoir; and
packaging said dispensing device including bait and said plurality of bait stations not including bait in a single kit.

19. The method of claim 18, further comprising:
providing instructions regarding using said dispensing device in conjunction with said bait stations to dispense bait into said bait stations.

20. The method of claim 18, wherein the amount of bait included in said dispensing device is more than sufficient to fill the bait reservoirs of each of said bait stations.

21. The method of claim 18, wherein said dispensing device comprises a syringe including a plunger that is slidably disposed in a proximal end of said syringe and a nozzle disposed at a distal end of said syringe.

22. The method of claim 18, wherein said bait stations each further comprise:
a one-way valve disposed within said filling aperture.

23. A bait station kit comprising:
a plurality of bait stations each comprising:
a top member defining a bait loading port, said top member having a first attachment member and at least one projection extending therefrom; and
a bottom member defining a bait reservoir, said bottom member having a second attachment member located therein which is configured to cooperate with said first attachment member to couple said top member to said bottom member, said bottom member also comprising at least one notch located therein which is configured to interact with said at least one projection extending from said top member to provide correct orientation of said top member with respect to said bottom member and/or to prevent rotation of said top member relative to said bottom member when said top member is coupled with said bottom member; and
a dispensing device including bait which dispensing device is configured to dispense said bait through each of said bait loading ports into each of said bait reservoirs.

24. The bait station kit of claim 23, wherein said second attachment member comprises:
an attachment cylinder having a first diameter portion and a second diameter portion of greater diameter than said first diameter portion;
wherein said first attachment member initially engages said first diameter portion and subsequently enters said second diameter portion when said first attachment member engages said second attachment member, and wherein said first attachment member is configured to expand upon entering said second diameter portion effectively locking said top member to said bottom member.

25. The bait station kit of claim 24, wherein said bait loading port is configured such that when a proper amount of bait has been dispensed into said bait reservoir said bait surrounds said second attachment member.

26. The bait station kit of claim 23, wherein said top member is either transparent or translucent.

27. The bait station kit of claim 23 wherein said top member comprises a top wall, and wherein said bait loading port is defined at an angle other than a substantially ninety degree angle with said top wall.
